(19) United States
(12) Patent Application Publication
(10) Pub. No.: US 2009/0111029 A1
(43) Pub. Date: Apr. 30, 2009

(54) ORGANIC ELETROLYE SOLUTION INCLUDING SILANE-BASED COMPOUND AND LITHIUM BATTERY USING THE SAME

(76) Inventors: Seok-soo Lee, Suwon-si (KR); Boris A. Trofimov, Irkutsk (RU); Young-gyoon Ryu, Suwon-si (KR); Seung-sik Hwang, Seongnam-si (KR); Dong-joon Lee, Seoul (KR)

Correspondence Address: STEIN, MCEWEN & BUI, LLP, 1400 EYE STREET, NW, SUITE 300, WASHINGTON, DC, 20005, US

(21) Appl. No.: 12/164,281

(22) Filed: Jun. 30, 2008

(30) Foreign Application Priority Data
Oct. 26, 2007 (KR) 2007-108439

(51) Int. Cl. H01M 6/16

(52) U.S. Cl. 429/324

(57) ABSTRACT

An organic electrolyte solution including: a lithium salt; an organic solvent including a high permittivity solvent and a low boiling solvent; and a silane-based compound represented by Formula 1 below:

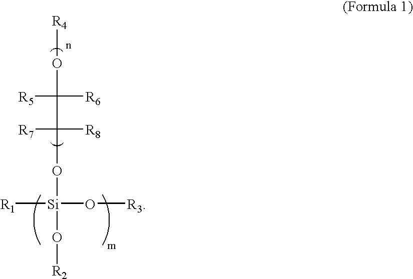

In Formula 1, m and n are each independently integers of from 1 to 30; and R₁, R₂, R₃, R₄, R₅, R₆, R₇, and R₈ are represented in the detailed description of the present invention. The organic electrolyte solution can be included in a lithium battery, so as to suppress the degradation of an electrolyte, and to improve cycle properties and life span of the battery.

### CROSS-REFERENCE TO RELATED APPLICATIONS

This application claims the benefit of Korean Patent Application No. 2007-108439, filed on Oct. 26, 2007, in the Korean Intellectual Property Office, the disclosure of which is incorporated herein in its entirety by reference.

### BACKGROUND OF THE INVENTION

1. Field of the Invention

Aspects of the present invention relate to an organic electrolyte solution including a silane-based compound, and a lithium battery using the same, and more particularly, to an organic electrolyte solution including a silane-based compound which can suppress the degradation of electrolytes, and a lithium battery using the organic electrolyte solution.

2. Description of the Related Art

As portable electronic devices, such as, video cameras, mobile phones, and notebook PCs become lighter and more functional;, much research is being conducted regarding batteries for these devices. Particularly, because secondary lithium batteries have an energy density per unit weight that is about 3 times higher than nickel-cadmium batteries, nickel-hydrogen batteries, nickel-zinc batteries, and the like, and can be rapidly charged, research and development is being carried out for lithium batteries.

Conventional lithium batteries operate at a high driving voltage, such that a traditional aqueous electrolyte cannot be used, because the lithium anode reacts vigorously with the aqueous solution. Therefore, an organic electrolyte solution, including a lithium salt dissolved in an organic solvent, is used in lithium batteries. The organic solvent may have high ion conductivity and permittivity, and a low viscosity. A single organic solvent satisfying all conditions is difficult to obtain, and therefore, a mixed solvent, including a high permittivity organic solvent and a low viscosity organic solvent, is used.

When a polar, non-aqueous carbonate solvent is used, the anode reacts with the electrolyte in the secondary lithium battery, consuming excess charges. Due to this irreversible reaction, a passivation layer, such as a solid electrolyte interface (SEI), is formed on the surface of the anode. The SEI prevents the electrolyte solution from degrading, thereby maintaining stable charging and discharging. Moreover, the SEI acts as an ion tunnel, by solvating lithium ions only, and prevent the intercalation of organic solvents into anodes, which move with the lithium ions, thereby preventing the anode structure from collapsing.

However, as the battery is charged and discharged at a high voltage of 4V, a rift can be gradually formed in the SEI, by the expansion and contraction of the active materials during the charge/discharge process. The SEI is eventually peeled away from the electrode surface. Therefore, as shown in FIG. 1, an electrolyte can directly contact the active material, resulting in the continuous degradation of the electrolyte. Once a rift is formed, the rift is enlarged during charge/discharge process, deteriorating the active materials. As a result, an SEI, made only of polar solvent and lithium salt, cannot maintain its ideal function as previously described. Consequently, an internal resistance of the anode increases, resulting in a decrease in the battery's capacity. In addition, the electrolyte content decreases, due to a degradation of the solvent, inhibiting ion transfer.

In order to solve the problems above and/or other problems, a procedure to prevent the direct contact of the anode active material and the electrolyte, while keeping lithium ion conductivity from decreasing, is in demand for improving the battery charge/discharge properties.

### SUMMARY OF THE INVENTION

Aspects of the present invention provide an organic electrolyte solution that blocks the direct contact of an anode active material and an electrolyte, without decreasing lithium ion conductivity.

Aspects of the present invention also provide a lithium battery including the electrolyte solution, which has improved cycle properties and life span.

According to an aspect of the present invention, there is provided an organic electrolyte solution including: lithium salt;

an organic solvent containing a high permittivity solvent; and

a silane-based compound represented by Formula 1 below:

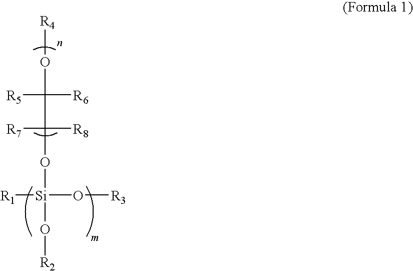

wherein m and n are each independently integers from 1 to 30; and

R₁, R₂, R₃, R₄, R₅, R₆, R₇, and R₈ each independently represent at least one selected from the group consisting of a hydrogen atom, a halogen atom, a hydroxyl group, a carboxyl group, an amino group, a cyano group, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C30 aryl group, a substituted or unsubstituted C7-C30 arylalkyl group, a substituted or unsubstituted C7-C30 alkylaryl group, a substituted or unsubstituted C1-C20 heteroalkyl group, and a substituted or unsubstituted C4-C30 heteroaryl group.

According to another aspect of the present invention, there is provided a lithium battery comprising:

a cathode;

an anode; and

the above organic electrolyte solution.

Additional aspects and/or advantages of the invention will be set forth, in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a schematic diagram illustrating the conventional cointercalation of electrolytes;

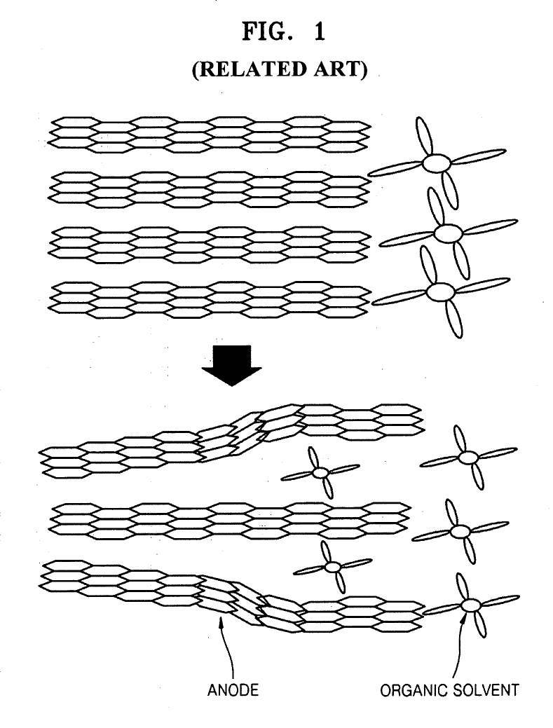

FIG. 2 is a schematic diagram illustrating an operating mechanism of a polymer film, according to aspects of the present invention;

FIG. 3 is a graph illustrating the cyclic properties of a lithium battery, according to Example 9 of the present invention; and

FIG. 4 shows a lithium battery 100, according to an exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

Aspects of the present invention provide an organic electrolyte solution including: lithium salt; an organic solvent containing a high permittivity solvent; and a silane-based compound represented by Formula 1 below:

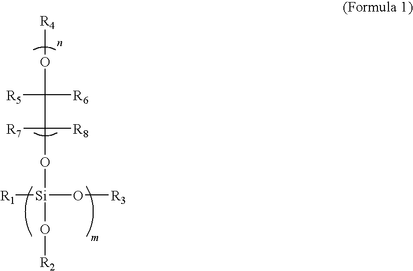

wherein m and n are each independently integers of 1 to 30; and

R₁, R₂, R₃, R₄, R₅, R₆, R₇, and R₈ each independently represent at least one selected from the group consisting of a hydrogen atom, a halogen atom, a hydroxyl group, a carboxyl group, an amino group, a cyano group, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C30 aryl group, a substituted or unsubstituted C7-C30 arylalkyl group, a substituted or unsubstituted C7-C30 alkylaryl group, a substituted or unsubstituted C1-C20 heteroalkyl group, and a substituted or unsubstituted C4-C30 heteroaryl group.

According to another exemplary embodiment of the present invention, the silane-based compound of Formula 1 may be represented by Formula 2 below:

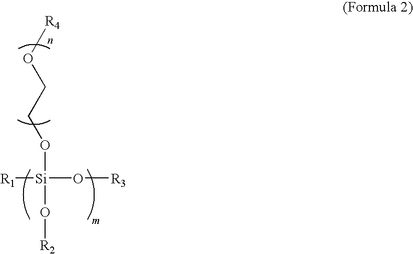

wherein m and n are each independent integers of 1 to 15; and

R₁, R₂, R₃, and R₄ each independently represent a C1-C10 substituted or unsubstituted alkyl group.

According to another exemplary embodiment of the present invention, the silane-based compound of Formula 2 may be represented by Formula 3 below:

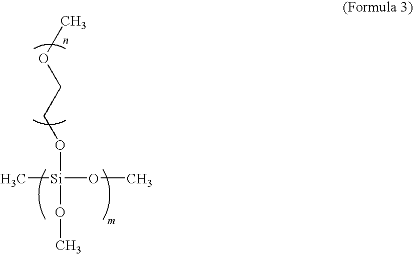

wherein m and n are each independent integers from 1 to 15.

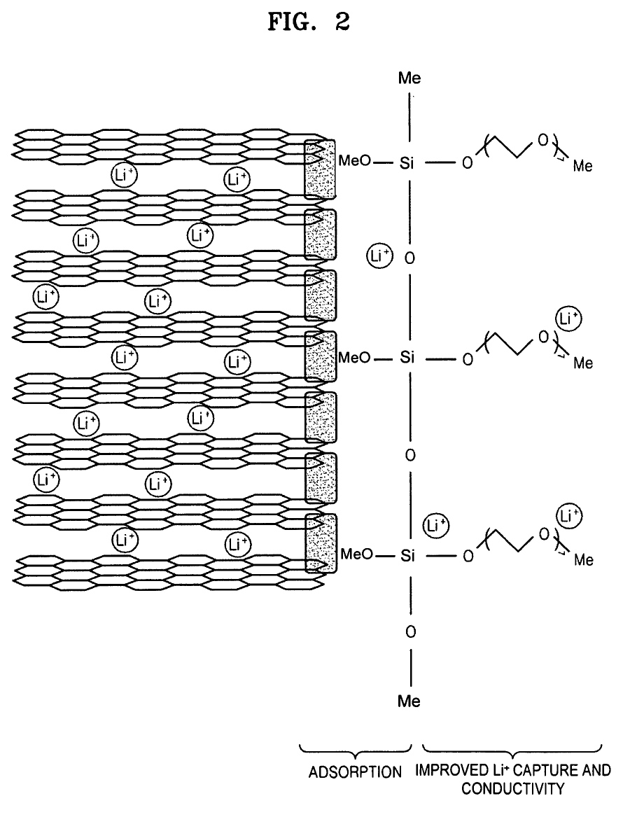

In the silane-based compound of Formula 1, as shown in FIG. 2, the —OR₂ functional group bound to the silane of is adsorbed by a surface of the electrode, and blocks contact between the electrolyte and the organic solvent, thereby preventing an irreversible reaction from occurring on the electrode-electrolyte interface. The polyethylene glycol functional group, which has a high affinity to the electrolyte, attracts lithium ions, and improves the conductivity of the captured lithium ions. Through this mechanism, a homogenous and stable film is formed on the surface of the electrodes, which enhances the initial efficiency and cycle efficiency of the battery.

The C1-C20 alkyl group may have a straight or branched structure. The alkyl group can be a C1-C12 alkyl group, C1-C8 alkyl group, or C1-C4 alkyl group. Specific examples include methyl, ethyl, propyl, isobutyl, sec-butyl, tert-butyl, pentyl, iso-amyl, and hexyl. At least one hydrogen atom included in the alkyl group may be substituted by a halogen atom, a hydroxyl group, a nitro group, or a cyano group.

The C1-C20 alkoxy group can be in the form of —O-alkyl, and the oxygen atom is linked to the main chain. The alkoxy group may be a C1-C12 alkoxy group, a C1-C8 alkoxy group, or a C1-C4 alkoxy group. Examples the alkoxy group may include a methoxy group, an ethoxy group, and a propoxy group. At least one hydrogen atom included in the alkoxy group may be substituted by one of a halogen atom, a hydroxyl group, a nitro group, a cyano group, and the like.

The C2-C20 alkenyl group may have a straight chain or branched structure, and is represented as having at least one unsaturated double bond within the alkyl group. At least one hydrogen atom included in the alkenyl group may be substituted by one of a halogen atom, a hydroxyl group, a nitro group, a cyano group, and the like.

The C2-C20 alkynyl group may have a straight chain, or branched structure, and is represented as having at least one unsaturated triple bond within the alkyl group. At least one hydrogen atom included in the alkenyl group may be substituted by one of a halogen atom, a hydroxyl group, a nitro group, a cyano group, and the like.

The C6-C30 aryl group can be a carbocycle aromatic system including at least one aromatic ring, and may be a C6-C20 aryl group, or a C6-C10 aryl group. The aromatic rings may be attached together by a pendant method, or may be fused. At least one hydrogen atom included in the aryl group may be substituted by one of a halogen atom, a hydroxyl group, a nitro group, a cyano group, and the like. Specific examples of the aryl group include a phenyl group, a halophenyl group (such as, an o-, m-, of p-fluorophenyl group, or a dichlorophenyl group), a cyano group, a dicyanophenyl group, a trifluoromethoxyphenyl group, a biphenyl group, a halobiphenyl group, a cyanobiphenyl group, a C1-C10 biphenyl group, a C1-C10 an alkoxybiphenyl group, an o-, m-, or p-tolyl group, o-, m-, and a p-cumenyl group, a mesityl group, a phenoxyphenyl group, a (α,α′-dimethylbenzene)phenyl group, an (N,N′-dimethyl)aminophenyl group, an (N,N′-diphenyl)aminophenyl group, a pentalenyl group, an indenyl group, a naphthyl group, a halonaphthyl group (such as a fluoronaphthyl group), a C1-C10 alkylnaphthyl group (such as a methylnaphthyl group), a C1-C10 alkoxynaphthyl group (such as a methoxynaphthyl group), a cyanonaphthyl group, an anthracenyl group, an azulenyl group, a heptalenyl group, an acenaphthylenyl group, a phenalenyl group, a fluorenyl group, an anthraquinonyl group, a methylanthryl group, a phenanthryl group, a triphenylene group, a pyrenyl group, a chrysenyl group, an ethyl-chrysenyl group, a picenyl group, a perilenyl group, a chloroperilenyl group, a pentaphenyl group, a pentacenyl group, a tetraphenylenyl group, a hexaphenyl group, a hexacenyl group, a rubicenyl group, a coroneryl group, a trinaphthylenyl group, a heptaphenyl group, a heptacenyl group, a pyranthrenyl group, and an oparenyl group.

The C7-C30 alkylaryl group can have at least one hydrogen atom of the aryl group, substituted with an alkyl group. A benzyl group may be an example, but is not limited thereto. At least one hydrogen atom included in the alkylaryl group may be substituted by one of a halogen atom, a hydroxyl group, a nitro group, a cyano group, and the like.

The C7-C30 arylalkyl group can have at least one hydrogen atom of the alkyl group, substituted with an alkyl group. Examples of such a group may be a 4-tert-butylphenyl group and a 4-ethylphenyl group, but are not limited thereto. At least one hydrogen atom included in the arylalkyl group may be substituted by one of a halogen atom, a hydroxyl group, a nitro group, a cyano group, and the like.

The C1-C20 heteroalkyl group can include a heteroatom such as an oxygen atom, a nitrogen atom, a sulfur atom, and a phosphorous atom within the main chain of the alkyl. At least one hydrogen atom included in the heteroalkyl group may be substituted by one of a halogen atom, a hydroxyl group, a nitro group, a cyano group, and the like.

The C4-C30 heteroaryl group can include at least one aromatic ring including at least one heteroatom selected from an oxygen atom, a nitrogen atom, a sulfur atom, and a phosphorous atom. The remaining atoms of the aromatic ring are carbon atoms, such that the at least pair of the atoms of the aromatic ring are fused together, or linked by a single bond. At least one hydrogen atom included in the heteroaryl group may be substituted by one of a halogen atom, a hydroxyl group, a nitro group, a cyano group, and the like.

In the case where at least one hydrogen atom, within the silane-based compound of Formula 1, is substituted with a halogen atom, a surface activity of the silane-based compound may be enhanced. In the case where a surface active compound is substituted with a halogen atom, such as fluorine, the surface activity may be further enhanced.

In the organic electrolyte solution, the content of the compound represented by Formula 1 may be 0.5 to 60 parts by weight, or may be 3 to 20 parts by weight, based on 100 parts by weight of the organic solvent including the high permittivity solvent. If the content is lower than 0.5 parts by weight, any improvement of the charge/discharge properties may be insufficient. If the content is higher than 60 parts by weight, the ion conductivity may decrease, due to a high viscosity.

The organic solvent included in the organic electrolyte solution may include a high permittivity solvent, which is not particularly limited, insofar as it is conventionally used in the art. Examples of such solvent include cyclic carbonates, such as ethylene carbonate, propylene carbonate, butylene carbonate, and γ-butylactone. Among the above, propylene carbonate can be safely used under a high voltage.

Besides the aforementioned high permittivity solvent, the organic solvent may further include a low-boiling point solvent, which may be a low-boiling point solvent conventionally used in the art, such as chain-type carbonates including dimethyl carbonate, ethylmethyl carbonate, diethyl carbonate, and dipropyl carbonate. The low boiling point solvent may be dimethoxy ethane, diethoxyethane, or fatty acid ester derivatives, but is not limited thereto.

When a mixture of the high permittivity solvent and the low-boiling point solvent is used as the organic solvent, the mixing ratio may be 1:1 to 1:9. If the ratio is outside of this range, the discharge capacity and the charge/discharge life span may not be desirable.

The lithium salt included in the organic electrolyte solution may be one that is conventionally used in the art. For example, the lithium salt may be at least one selected from the group consisting of LiClO₄, LiCF₃SO₃, LiPF₆, LiN(CF₃SO₂), LiBF₄, LiC(CF₃SO₂)₃, and LiN(C₂F₅SO₂)₂. The concentration of the lithium salt within the organic electrolyte solution may be 0.5 to 2M. If the concentration is lower than 0.5M, the conductivity of the electrolyte solution decreases, thereby deteriorating the quality of the electrolyte solution. If the concentration is higher than 2.0M, the viscosity of the electrolyte solution increases, thereby decreasing the mobility of the lithium ions.

The organic electrolyte solution, according to some exemplary embodiments, includes LiClO₄ as the lithium salt, propylene carbonate as the high permittivity solvent, and the silane-based compound of Formula 3, as the silane-based compound of Formula 1.

Hereinafter, a lithium battery using the organic electrolyte solution described above, and a method of manufacturing the lithium battery, will be described. The lithium battery, according to aspects of the present invention, includes a cathode, an anode, and an organic electrolyte solution. The organic electrolyte solution includes a lithium salt, a high permittivity solvent-containing an organic solvent, and a silane-based compound of Formula 1. The lithium battery does not have a particularly limited structure, and lithium secondary batteries, such as lithium ion batteries, lithium-ion polymer batteries, and lithium-sulfur batteries, as well as lithium primary batteries, may be used.

The lithium battery of the present invention may be manufactured as follows. First, a cathode active material, a conductive agent, a binding agent, and a solvent are mixed to prepare a cathode active material composition. The cathode active material composition may be directly coated on an aluminum current collector, and dried, to prepare a cathode plate, or the cathode active material composition may be cast on a separate support, followed by laminating a film exfoliated from the support onto the aluminum current collector, to produce a cathode.

The cathode active material may be a lithium-containing metal oxide, which can be any such metal oxide that is conventionally used in the art. For example, the lithium-containing metal oxide may include LiCoO₂, LiMnₓO₂ₓ, LiNi₁₋ₓMnₓO₂ₓ (x=1, 2), and/or Li_{1-x-y}CoₓMn_{y}O₂ (0≦x≦0.5, 0≦y≦0.5).

Carbon black may be used as the conductive agent. For the binding agent, a vinylidene fluoride/hexafluoropropylene copolymer, polyvinylidenefluoride (PVdF), polyacrylonitrile, polymethylmethacrylate (PMMA), polytetrafluoroethylene, mixtures thereof, and a styrene butadiene rubber-based polymer may be used. For the solvent, N-methylpyrrolidone (NMP), acetone, and/or water may be used. Conventional amounts of the cathode active material, the conductive agent, the binding agent, and the solvent may be used.

Using the steps of manufacturing the cathode plate described above, an anode active material composition is prepared, by mixing an anode active material, a conductive agent, a binding agent, and the solvent. The mixture can be directly coated on a copper current collector to obtain an anode plate. Alternatively, the mixture can be cast on a separate support, the anode active material film is exfoliated from the support, and is then laminated on the copper current collector, to obtain an anode plate. Conventional amounts of the anode active material, the conductive agent, the binding agent, and the solvent may be used.

For the anode active material, silicon metal, a silicon film, lithium metal, a lithium alloy, a carbon material, or graphite may be used. The conductive agent, the binding agent, and the solvent within the anode active material composition may be the same as those used for the cathode. If necessary, a plasticizer may be added to the cathode active material composition. The anode active material composition forms pores within the electrode plates.

As a separator, any material used conventionally for lithium batteries may be used. Particularly, a separator with a superior electrolyte solution hydrating capacity, and with a low resistance against electrolyte ion mobility, is desirable. For example, a glass fiber, polyester, Teflon, polyethylene, polypropylene, polytetraflouroethylene (PTFE), and a combination selected therefrom, may be used, in either a woven and non-woven network. In more detail, lithium ion batteries may use a separator that can be coiled, such as polyethylene and polypropylene. Lithium ion polymer batteries may use a separator with a superior ability to impregnate organic electrolyte solutions, and such separators can be manufactured according to the following method.

A polymer resin, a filler, and a solvent are mixed, to produce a separator composition. The separator composition can be directly coated on the electrodes, and dried, to form a separator film, or the separator composition may be cast on a support, dried, exfoliated from the support, and then laminated, to form the separator film on the electrodes.

The polymer resin is not particularly limited, insofar as the resin is used in a binding agent of the electrodes. For example, a vinylidene fluoride/hexafluoropropylene copolymer, polyvinylidenefluoride, polyacrylonitrile, polymethylmethacrylate, and a blend thereof may be used. In particular, the vinylidene fluoride/hexafluoropropylene copolymer mixed with 8 to 25 wt % of the hexafluoropropylene, may be used.

The separator is interposed between the cathode plate and the anode plate, and a battery structure is formed. Such a battery structure can be wound or folded into a cylindrical battery case, or an angular battery case. The organic electrolyte solution is injected to complete the lithium ion battery. The battery structure can be stacked into a bi-cell structure, which can be impregnated in the organic electrolyte solution, placed in a pouch, and sealed to complete a lithium-ion polymer battery.

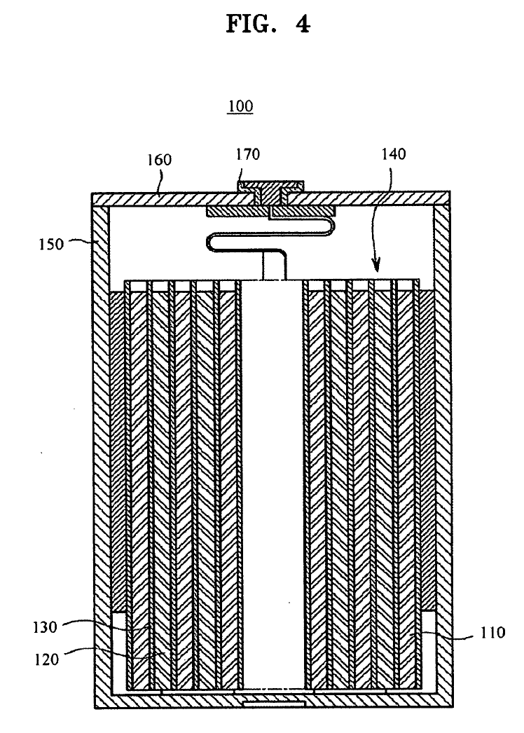

As shown in FIG. 4, aspects of the present invention provide a lithium battery 100. The lithium battery 100 includes: an electrode assembly 140; a case 150 to house the electrode assembly; a cap plate 160 to seal an opening of the case 150; and a gasket 170 to seal an opening of the cap plate 160. The electrode assembly 140 includes an anode electrode 110, a cathode electrode 120, and a separator 130 disposed therebetween. An electrolyte ((organic electrolyte solution (not shown)) is injected into the case 150, after the electrode assembly 140 is inserted into the case 150.

Hereinafter, the present invention is described more in detail with reference to exemplary embodiments, but the present invention is not confined thereto.

### EXAMPLE 1

### Preparation of Electrolyte Solution

1 wt % of the compound of Formula 3a below, as an additive, and 1 M of LiClO₄, as a lithium salt, were added to an organic solvent made of propylene carbonate, to prepare an organic electrolyte solution.

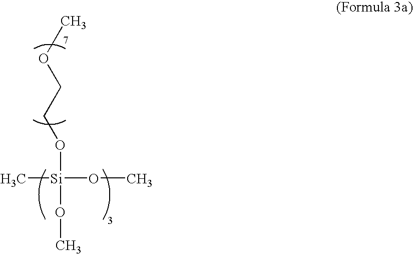

### EXAMPLE 2

### Preparation of Electrolyte Solution

3 wt % of the compound of Formula 3a above, as an additive, and 1M of LiClO₄, as a lithium salt, were added to an organic solvent made of propylene carbonate, to prepare an organic electrolyte solution.

### EXAMPLE 3

### Preparation of Electrolyte Solution

5 wt % of the compound of Formula 3a above, as an additive, and 1M of LiClO₄, as a lithium salt, were added to an organic solvent made of propylene carbonate, to prepare an organic electrolyte solution.

### EXAMPLE 4

### Preparation of Electrolyte Solution

10 wt % of the compound of Formula 3a above, as an additive, and 1M of LiClO₄, as a lithium salt, were added to an organic solvent made of propylene carbonate, to prepare an organic electrolyte solution.

### EXAMPLE 5

### Preparation of Electrolyte Solution

20 wt % of the compound of Formula 3a above, as an additive, and 1M of LiClO₄, as a lithium salt, were added to an organic solvent made of propylene carbonate, to prepare an organic electrolyte solution.

### EXAMPLE 6

5 wt % of the compound of Formula 3b below, as an additive, and 1M of LiClO₄, as a lithium salt, were added to an organic solvent made of propylene carbonate, to prepare an organic electrolyte solution.

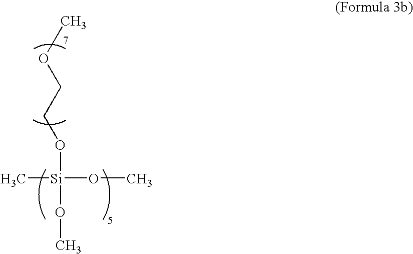

### COMPARATIVE EXAMPLE 1

### Preparation of Electrolyte Solution

1M of LiCl₄, was added as a lithium salt to an organic solvent made of propylene carbonate, to prepare an organic electrolyte solution.

### EXAMPLE 7

### Manufacture of Lithium Ion Battery

A graphite powder of MCMB (mesocarbon microbeads by Osaka Gas Chemicals Co.) and a binding agent of N-methylpyrrolidone (NMP) with polyvinylidenefluoride (PVdF) dissolved at 5 wt %, were added to an agate mortar, at a weight ratio of 95:5 respectively, and were mixed thoroughly, to form a slurry. The slurry was cast on a copper foil with a thickness of 19 μm, with a doctor blade, at a length of 100 μm, to obtain an anode. The resulting product was placed in a 90° C. oven and was primary dried for 2 hours, to evaporate the NMP, and was then secondary dried for 2 hours in a 120° C. oven, to dry the NMP. Then, the electrode was mill-rolled to obtain an anode with a thickness of 60um.

Using the anode obtained above, with lithium metal as the counter electrode, polyethylene as the separator, and using the organic electrolyte solution obtained from Example 1, a 2016-type coin cell was manufactured.

### EXAMPLE 8

### Manufacture of Lithium Ion Battery

A coin cell was manufactured using the same method as in Example 7 above, except that the organic electrolyte solution obtained from Example 1 was replaced with the organic electrolyte solution obtained from Example 2.

### EXAMPLE 9

### Manufacture of Lithium Ion Battery

A coin cell was manufactured using the same method as in Example 7 above, except that the organic electrolyte solution obtained from Example 1 was replaced with the organic electrolyte solution obtained from Example 3.

### EXAMPLE 10

### Manufacture of Lithium Ion Battery

A coin cell was manufactured using the same method as in Example 7 above, except that the organic electrolyte solution obtained from Example 1 was replaced with the organic electrolyte solution obtained from Example 4.

### EXAMPLE 11

### Manufacture of Lithium Ion Battery

A coin cell was manufactured using the same method as Example 7 above, except that the organic electrolyte solution obtained from Example 1 was replaced with the organic electrolyte solution obtained from Example 5.

### EXAMPLE 12

### Manufacture of Lithium Ion Battery

A coin cell was manufactured using the same method as in Example 7 above, except that the organic electrolyte solution obtained from Example 1 was replaced with the organic electrolyte solution obtained from Example 6.

### COMPARATIVE EXAMPLE 2

### Manufacture of Lithium Ion Battery

A coin cell was manufactured using the same method as Example 7 above, except that the organic electrolyte solution obtained from Comparative Example 1 was used instead of the organic electrolyte solution obtained from Example 1.

### Experiment Example 1

### Charge/Discharge Testing of Batteries

The coin cells manufactured in Examples 7 to 11, Comparative Example 2, and Example 12, with cell capacities of 1.54 mAh and 2.2 mAh were each charged under constant-current, at a rate of 0.1 C, until 0.001V was reached at Li electrode. The cells were then were charged under a constant-voltage at 0.001V, until the current reached a 0.02 C rate against the cell capacity. Consequently, a constant-current discharge was performed to the charged coin cells at a 0.1 C rate of the coin cells, until the voltage reached 1.5V, from which the charge/discharge capacity was obtained. Charge/discharge efficiencies were calculated therefrom. The charge/discharge efficiency is represented by the Mathematical Formula 1, below:

### <Mathematical Formula 1>

Initial charge/discharge efficiency (%)=Discharge capacity of 1^{st} cycle/ charge capacity of 1^{st} cycle

The calculated results are shown in Table 1 below:

TABLE 1

First Cycle

| | Charge | Discharge | Initial |
|---|---|---|---|
| | Capacity | Capacity | Charge/Discharge |
| Samples | (mAh) | (mAh) | Efficiency(%) |
| Example 7 | 2.75 | 1.3 | 47 |
| Example 8 | 1.8 | 1.21 | 66 |
| Example 9 | 1.8 | 1.21 | 67 |
| Example 10 | 1.73 | 1.25 | 74 |
| Example 11 | 1.5 | 1.24 | 81 |
| Example 12 | 3.02 | 1.97 | 65 |
| Comparative | — | — | — |
| Example 2 | | | |

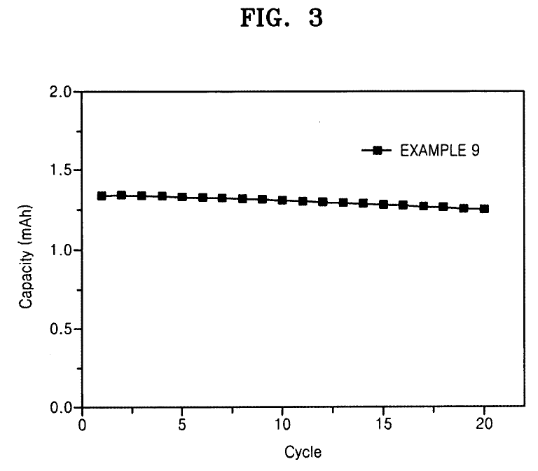

The coin cell obtained from Example 9 was put under 20 cycles of a charge/discharge process, as recited above, and the results were shown in FIG. 3.

As shown in Table 1 and FIG. 3, the charge/discharge occurred reversibly for the coin cells manufactured according to Examples 7 to 12, which used the silane-based additive of Formulas 3a and 3b, and showed an initial charge/discharge efficiency value of at least 70%. However, in the case of Comparative Example, where the additive was not used, the solvent was degraded by cointercalation, resulting in a nonfunctional battery. In the case of Example 9, where the silane-based additive of Formula 3a was used, it can be seen from the cycle graph of FIG. 3 that the capacity preservation characteristic was good, even at 20^{th} charge/discharge cycle.

In the organic electrolyte solution, according to aspects of the present invention, and a lithium battery using the same, unlike the conventional organic electrolyte solution, where an irreversible capacity increases due to polar solvent degradation, uses a silane-based compound represented by Formula 1, as an additive, to suppress the formation of rifts on the anode active material, during a battery charge/discharge. The electrolyte solution provides superior charge/discharge properties, stability, reliability, and a high charge/discharge efficiency in a battery.

Although a exemplary few embodiments of the present invention have been shown and described, it would be appreciated by those skilled in the art that changes may be made in these embodiments, without departing from the principles and spirit of the invention, the scope of which is defined in the claims and their equivalents.

What is claimed is:

1. An organic electrolyte solution comprising:
lithium salt;
an organic solvent containing high permittivity solvent; and
a silane-based compound represented by Formula 1 below: 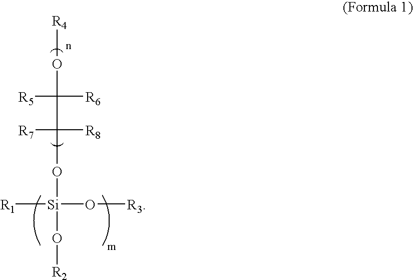
wherein m and n are each independently integers of from 1 to 30; and
R₁, R₂, R₃, R₄, R₅, R₆, R₇, and R₈ each independently represent at least one selected from the group consisting of a hydrogen atom, a halogen atom, a hydroxyl group, a carboxyl group, an amino group, a cyano group, a substituted or unsubstituted C1-C20 alkyl group, a substituted or unsubstituted C1-C20 alkoxy group, a substituted or unsubstituted C2-C20 alkenyl group, a substituted or unsubstituted C2-C20 alkynyl group, a substituted or unsubstituted C6-C30 aryl group, a substituted or unsubstituted C7-C30 arylalkyl group, a substituted or unsubstituted C7-C30 alkylaryl group, a substituted or unsubstituted C1-C20 heteroalkyl group, and a substituted or unsubstituted C4-C30 heteroaryl group.

2. The organic electrolyte solution of claim 1, wherein the silane-based compound of Formula 1 is a compound represented by Formula 2 below: 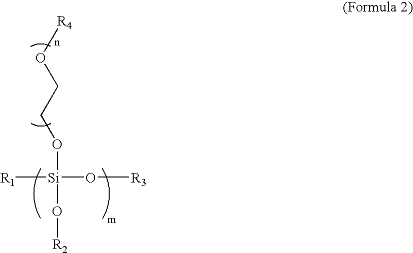
wherein m and n are each independent integers of 1 to 15; and R₁, R₂, R₃, and R₄ each independently represent a C1-C10 substituted or unsubstituted alkyl group.

3. The organic electrolyte solution of claim 1, wherein the silane-based compound of Formula 1 is a compound represented by Formula 3 below: 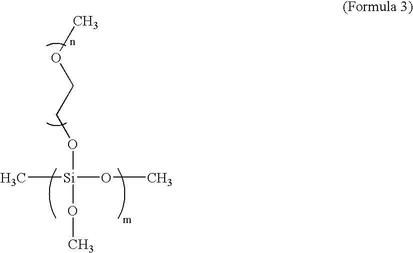
wherein m and n are each independent integers of 1 to 15.

4. The organic electrolyte solution of claim 1, wherein the silane-based compound of Formula 1 is included at from 0.5 to 60 parts by weight, based on 100 parts by weight of the organic solvent.

5. The organic electrolyte solution of claim 1, wherein the silane-based compound is included at 1 to 20 parts by weight, based on 100 parts by weight of the organic solvent.

6. The organic electrolyte solution of claim 1, wherein the high permittivity solvent is at least one selected from the group consisting of ethylene carbonate, propylene carbonate, butylene carbonate, and γ-butylactone.

7. The organic electrolyte solution of claim 1, wherein the high permittivity solvent is propylene carbonate.

8. The organic electrolyte solution of claim 1, wherein the organic solvent further comprises a low boiling point solvent.

9. The organic electrolyte solution of claim 8, wherein the low boiling point solvent is at least one selected from the group consisting of dimethyl carbonate, ethylmethyl carbonate, diethyl carbonate, dipropyl carbonate, dimethoxyethane, diethoxyethane and a fatty acid ester derivative thereof.

10. A lithium battery comprising:
a cathode;
an anode; and
an organic electrolyte solution according to claim 1.

11. A lithium battery comprising:
a cathode;
an anode; and
an organic electrolyte solution according to claim 2.

12. A lithium battery comprising:
a cathode;
an anode; and
an organic electrolyte solution according to claim 3.

13. A lithium battery comprising:
a cathode;
an anode; and
an organic electrolyte solution according to claim 4.

14. A lithium battery comprising:
a cathode;
an anode; and
an organic electrolyte solution according to claim 5.

15. A lithium battery comprising:
a cathode;
an anode; and
an organic electrolyte solution according to claim 6.

16. A lithium battery comprising:
a cathode;
an anode; and
an organic electrolyte solution according to claim 7.

17. A lithium battery comprising:
a cathode;
an anode; and
an organic electrolyte solution according to claim 8.

18. A lithium battery comprising:
a cathode;
an anode; and
an organic electrolyte solution according to claim 9.
